(19) United States
(12) Patent Application Publication
(10) Pub. No.: US 2009/0224078 A1
(43) Pub. Date: Sep. 10, 2009

(54) BIODEGRADABLE IRRIGATION DRIP TAPE AND METHOD OF USING SAME

(76) Inventor: Noel W. Anderson, Fargo, ND (US)

Correspondence Address: TAYLOR & AUST, P.C., P.O. Box 560, 142. S Main Street, Avilla, IN, 46710, US

(21) Appl. No.: 12/041,783

(22) Filed: Mar. 4, 2008

(51) Int. Cl. B05B 15/00; A01G 25/02; C08F 6/06

(52) U.S. Cl. 239/542; 222/251; 222/71; 528/491

(57) ABSTRACT

An agricultural irrigation assembly includes a water supply header and a plurality of drip tapes fluidly coupled with the supply header. Each drip tape consists essentially of a biodegradable plastic material. A catalyst dispenser is in fluid communication with the supply header. The catalyst dispenser contains a catalyst for initiating fast degradation of the biodegradable plastic material.

### FIELD OF THE INVENTION

The present invention relates to agricultural irrigation systems, and, more particularly, to agricultural drip irrigation systems.

### BACKGROUND OF THE INVENTION

Agricultural irrigation systems have been used for centuries to apply water to agricultural crops. The first type of irrigation systems were flood irrigation systems in which trenches formed in the soil directed water via gravitational force to an agricultural site. For example, water can be diverted from a river by a gated trench to an agricultural site at a lower elevation. These type of irrigation systems are still in use today in certain areas where water sources and the topography allow, e.g., certain areas of the western U.S.A. and Australia.

Other more mechanized types of irrigation systems are also used. For example, center pivot irrigation systems of the high pressure or low pressure type receive water from an electric powered water pump. The water typically is pumped from a well, river or irrigation pond. Intermittently spaced towers carrying a supply pipe are driven by electric motors or water driven turbines.

Other types of irrigation systems such as “travelers” are also used. In a traveler system, a flexible hose is coupled with a standpipe in a field supplied by a water pump, and a cable is drawn across the field. The water passes through a water driven turbine prior to exiting from a pivoting gun, and the water turbine reels up the cable on a spool, causing the traveler to move across the field dragging the hose behind.

With a center pivot or traveler irrigation system as described above, an appreciable amount of the water is lost through evaporation as the water travels through the air, and through run-off after the water falls to the ground. To reduce evaporation, such irrigation systems may be operated at night. However, depending upon the amount of acreage to irrigate, it may be necessary to operate the irrigation system around the clock, 7 days a week.

Another more recent type of irrigation is drip irrigation, in which water flows at a low pressure (e.g., typically 5 to 15 psi) through a flattened tube and is discharged through openings in the tube in close proximity to the plants. The water exits at a low pressure from the flattened tube, and is thus also referred to as a “drip tape.” A supply header receives water from a water pump and a plurality of the drip tapes are coupled with the supply header in a network of drip tapes corresponding to the particular shape of the field.

A drip irrigation system as described above has the advantages of directly delivering water and nutrients to an area in close proximity to the plants which maximizes plant growth and production, while limiting problems associated with other types of irrigation systems, such as erosion, disease, weed growth, soil saturation, energy costs and water conservation.

Various examples of drip irrigation systems are manufactured and marketed by Roberts Irrigation Products, Inc., San Marcos, Calif., which in turn is a subsidiary of the assignee of the present invention. (see, e.g., the website www.robertsirrigation.com).

A problem with drip tape irrigation is that the drip tapes are placed within the ground at a level that may interfere with subsequent field operations. It is possible to use special equipment to remove the drip tape from the field, but this adds more cost and time to the field operations. It is also possible that the drip tape which is removed from the ground may be reused, but when it can no longer be used, it must be hauled to and disposed of in a landfill, which also adds cost.

What is needed in the art is an agricultural drip tape that can be used for irrigation over a minimum period of time, and then quickly degraded upon finishing irrigation so as to not require removal from the field or interfere with subsequent field operations.

### SUMMARY OF THE INVENTION

The invention in one form is directed to an agricultural irrigation assembly, including a water supply header and a plurality of drip tapes fluidly coupled with the supply header. Each drip tape consists essentially of a biodegradable plastic material. A catalyst dispenser is in fluid communication with the supply header. The catalyst dispenser contains a catalyst for initiating fast degradation of the biodegradable plastic material.

The invention in another form is directed to a method of using irrigation drip tape for the irrigation of soil, including the steps of: transporting water through a water supply header and a plurality of drip tapes fluidly coupled with the supply header, each drip tape consisting essentially of a biodegradable plastic material; irrigating the soil using water flowing through a plurality of emitters formed in each drip tape; dispensing a catalyst from a catalyst dispenser into the supply header and the plurality of drip tapes; and degrading the biodegradable plastic material using the catalyst.

### BRIEF DESCRIPTION OF THE DRAWINGS

FIG. 1 is a schematic illustration of an embodiment of a drip irrigation assembly of the present invention.

### DETAILED DESCRIPTION OF THE INVENTION

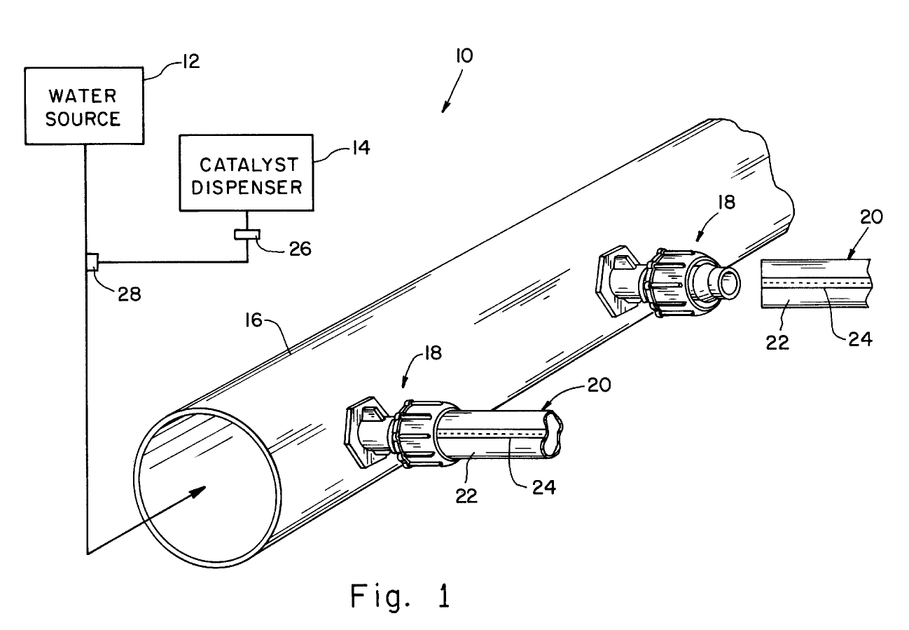

Referring now to FIG. 1, there is shown an embodiment of an agricultural irrigation assembly 10, including a water source 12, catalyst dispenser 14, irrigation hose 16, a pair of couplers 18 and a pair of drip tapes 20.

Water source 12 is fluidly coupled with and provides water to irrigation hose 16. Water source 12 can have a number of configurations which provide water at a selected operating pressure to irrigation hose 16, such as in the 5-15 p.s.i. pressure range. For example, water source 12 can include a water pump with a selected output pressure to irrigation hose 16. Alternatively, water source 12 can be an above-ground storage tank set at a level providing a desired pressure head to irrigation hose 16.

Irrigation hose 16 acts as a supply header to drip tape 20, such as when configured as a sub-main line. In the embodiment shown, irrigation hose 16 is configured as a lay flat hose and used as a sub-main line.

Couplers 18 fluidly interconnect irrigation hose 16 with the plurality of drip tapes 20. Couplers 18 may be of conventional design, and thus are not described further herein.

Drip tapes 20 are typically connected in a parallel manner to each other, perpendicular to irrigation hose 16, and extend across a field or other area to be irrigated. Irrigation assembly 10 typically includes more than the two drip tapes 20 coupled with irrigation hose 16, depending upon the size and shape of the land area to be irrigated. However, only a pair of drip tapes 20 are shown connected to irrigation hose 16 for simplicity sake.

Drip tapes 20 may be of known construction, and generally include a sidewall 22 with opposite longitudinal edges which are overlapped and affixed to each other to define an overlap channel 24 with a plurality of spaced emitters (shown as small perforations, but not numbered) through which water is discharged at low pressure. Although drip tapes 20 are shown with a flattened, tape-like construction, it is possible to use other types of irrigation conduits with the present invention which are also known to be used in drip irrigation systems, such as irrigation conduits having oval or circular cross sections.

According to another aspect of the present invention, drip tapes 20 are formed from a non-hydrocarbon based, biodegradable plastic. Without limitation, examples of biodegradable plastics include polymeric and polyester materials of many specific types. In the specific embodiment shown, drip tapes 20 are preferably formed from a polyhydroxyalkanoate (PHA) polymer. As further examples of biodegradable plastics, drip tapes 20 can also be formed from a poly(3-hydroxybutyrate) (P3HB) polyester, polyhydroxyalkanoates, poly(k-caprolactone), poly(l-lactide), and both aliphatic and aromatic polyalkylene dicarboxylic acids.

According to another aspect of the present invention, drip tapes 20 may be rapidly biodegraded “on command” upon introduction of a catalyst into irrigation hose 16 and drip tapes 20 from catalyst dispenser 14. This is accomplished by irrigating with the catalyst entrained in the irrigation water for a short time when fast degradation is desired. Depending upon the type of biodegradable plastic that is selected, a corresponding specific catalyst can be introduced into drip tapes 20 to initiate the chemical reaction both on the inside and outside of drip tapes 20. That is, the catalyst entrained water on the inside of drip tapes 20 initiates the biodegradation from the inside of drip tapes 20, and the catalyst entrained water in the water soaked soil on the outside of drip tapes 20 initiates the biodegradation from the outside of drip tapes 20.

The catalyst used to initiate degradation can be in the form of a specific chemical or enzyme, depending upon the specific biodegradable plastic. Additionally, the temperature of the water carrying the catalyst can be varied (e.g., increased) to further assist in initiating the biodegradation process. For example, it may be possible to introduce a strong alkali solution at an elevated temperature within drip tapes 20 to initiate the biodegradation process. As another example, it may be possible to introduce an organic catalyst such as an enzyme in solution within drip tapes 20 to initiate the biodegradation process.

The ability to degrade PHA is widely distributed among bacteria and fungi and depends on the secretion of specific extracellular PHA depolymerases (e-PHA depolymerases), which are carboxyesterases (EC 3.1.1.75 and EC 3.1.1.76), and on the physical state of the polymer (amorphous or crystalline). The activities of these enzymes may vary and depend on the composition of the polymer, its physical form (amorphous or crystalline), the dimensions of the sample, and, importantly, the environmental conditions.

PHA depolymerases secreted extracellularly by microorganisms such as Alcaligenes faecalis, Comamonas acidovorans, Pseudomonas picketii, Pseudomonas lemoignei, Pseudomonas testosteroni, Penicillium pinophilum etc. have been confirmed as representative enzymes decomposing PHA. It is revealed that the active site of these enzymes is a serine residue and the enzyme activity is greatly influenced by the degree of crystallinity of the polyester. Lipase produced by fungi such as Rizopus delemer etc. has also been confirmed as an enzyme decomposing PHA and is known to decompose side-chain-free PHA's such as polypropyllactone and polycaprolactone.

As a further example, it may be possible to introduce microorganisms that could be put in the water which then latch onto drip tapes 20 and produce enzymes to initiate the biodegradation process. Thus, anything that rapidly degrades drip tapes 20 “on command”, such as chemicals, enzymes and microorganisms producing enzymes, are all intended to be within the meaning of the term “catalyst” as used herein.

In the embodiment shown in FIG. 1, catalyst dispenser 14 is configured as a bulk tank with a metering disk 26 and a venturi nozzle 28. Depending upon the size of an orifice (not shown) in metering disk 26, the flow rate of the catalyst into irrigation hose 16 can be controlled. Venturi nozzle 28 is sized an shaped to induce a flow of the catalyst into the passing flow of water from water source 12. These types of metering disk and venturi arrangements are used with other types of irrigation equipment (e.g., center pivots and travelers) and will not be described further.

As another example, catalyst dispenser 14 can include a bulk tank and a metering pump, such as a chemical resistant diaphragm pump. These types of pumps are also used with other types of irrigation equipment and will not be described further.

Having described the preferred embodiment, it will become apparent that various modifications can be made without departing from the scope of the invention as defined in the accompanying claims.

1. An agricultural irrigation assembly, comprising:
a water supply header;
a plurality of drip tapes fluidly coupled with said supply header, each said drip tape consisting essentially of a biodegradable plastic material; and
a catalyst dispenser in fluid communication with said supply header, said dispenser containing a catalyst for initiating fast degradation of said biodegradable plastic material.

2. The agricultural irrigation assembly of claim 1, wherein said biodegradable plastic material consists essentially of a polyhydroxyalkanoate (PHA) polymer.

3. The agricultural irrigation assembly of claim 1, wherein said catalyst consists essentially of one of a chemical and an enzyme.

4. The agricultural irrigation assembly of claim 1, wherein said catalyst is an organic catalyst.

5. The agricultural irrigation assembly of claim 4, wherein said catalyst is an enzyme.

6. The agricultural irrigation assembly of claim 5, wherein said catalyst is a microorganism producing an enzyme.

7. The agricultural irrigation assembly of claim 1, wherein said catalyst dispenser is metered into said supply header by one of a pump and a venturi.

8. The agricultural irrigation assembly of claim 1, wherein said catalyst is metered into said supply header and degrades said biodegradable plastic in less than 24 hours.

9. The agricultural irrigation assembly of claim 8, wherein said supply header is made from a material which is substantially unaffected by said catalyst.

10. The agricultural irrigation assembly of claim 1, wherein said supply header is an irrigation hose.

11. A method of using irrigation drip tape for the irrigation of soil, comprising the steps of:
transporting water through a water supply header and a plurality of drip tapes fluidly coupled with said supply header, each said drip tape consisting essentially of a biodegradable plastic material;
irrigating the soil using water flowing through a plurality of emitters formed in each said drip tape;
dispensing a catalyst from a catalyst dispenser into said supply header and said plurality of drip tapes; and
degrading said biodegradable plastic material using said catalyst.

12. The method of using irrigation drip tape of claim 11, wherein said dispensing step includes metering said catalyst into said supply header using one of a pump and a venturi.

13. The method of using irrigation drip tape of claim 11, wherein said dispensing step includes metering said catalyst into said supply header, and said degrading step degrades said biodegradable plastic in less than 24 hours.

14. The method of using irrigation drip tape of claim 13, wherein said supply header is made from a material which is substantially unaffected by said catalyst.

15. The method of using irrigation drip tape of claim 11, wherein said biodegradable plastic material consists essentially of a polyhydroxyalkanoate (PHA) polymer.

16. The method of using irrigation drip tape of claim 11, wherein said catalyst consists essentially of one of a chemical and an enzyme.

17. The method of using irrigation drip tape of claim 11, wherein said catalyst is an organic catalyst.

18. The method of using irrigation drip tape of claim 17, wherein said catalyst is an enzyme.

19. The method of using irrigation drip tape of claim 18, wherein said catalyst is a microorganism producing an enzyme.

20. The method of using irrigation drip tape of claim 11, wherein said supply header is an irrigation hose.
